(19) United States
(12) Patent Application Publication
(10) Pub. No.: US 2006/0047610 A1
(43) Pub. Date: Mar. 2, 2006

(54) System and method for providing exception handling instructions to a delivery agent

(76) Inventors: Arthur J. Parkos, Southbury, CT (US); Deborra J. Zukowski, Newtown, CT (US)

Correspondence Address: Pitney Bowes Inc.;Intellectual Property and Technology Law Dept., 35 Waterview Drive, P.O. Box 3000, Shelton, CT, 06484, US

(21) Appl. No.: 10/930,466

(22) Filed: Aug. 31, 2004

(51) Int. Cl. G06F 17/00

(52) U.S. Cl. 705/410

(57) ABSTRACT

A method includes detecting an event which occurs during transportation of a mailpiece on the way from a sender to an addressee. The method further includes determining instructions provided by the sender regarding at least one action to be taken upon occurrence of the event. The instructions are then carried out. In some circumstances, the event may be a delay in delivery of the mailpiece due to contamination or quarantining, and the sender's instructions may specify a manner in which the contents of the mailpiece may be forwarded to the addressee while the mailpiece remains quarantined.

### BACKGROUND

This invention relates generally to the field of managing mail.

Some systems for delivering letters or parcels include tracking systems that allow the senders of the letters or parcels to receive reports of the progress of the letters or parcels through the delivery systems. However, such systems do not generally provide flexibility or choices for senders.

In addition, postal services or other mailpiece delivery systems have been shown to be vulnerable to attacks such as the widely publicized anthrax attacks of a few years ago. In case of such an attack, large quantities of mail may be contaminated and/or quarantined, resulting in an indefinite and possibly permanent delay in delivery of the mail. As a result, the channel of communication represented by the delivery system may be disrupted.

### SUMMARY

Accordingly, methods are provided for responding to events that occur during the course of a mailpiece's progress through a delivery system.

In one aspect, a method includes detecting an event which occurs during transportation of a mailpiece on the way from a sender to an addressee, determining instructions provided by the sender regarding at least one action to be taken upon occurrence of the event, and following the instructions. Many event detectors are well known such as hazardous material detectors.

As used herein and in the appended claims, “mailpiece” includes but is not limited to letters and parcels carried by the U.S. Postal Service or other postal authority, and further includes letters, envelopes, parcels or any other physical item appointed for delivery to an addressee.

The event may be a delay in transporting the mailpiece and/or quarantining the mailpiece on account of contamination of the mailpiece. The event may be delivery of the mailpiece to a post office box and following the instructions may include sending an electronic mail message to the addressee to inform the addressee of the delivery.

Following the instructions may in some cases include opening the mailpiece and scanning a document contained in the mailpiece to generate the scanned data. The scanned data may be image data and/or text data generated by optical character recognition applied to the scanned document. The scanned data may by transmitted to the addressee via electronic mail or in the form of a facsimile message. A facsimile machine telephone number for the addressee and/or an electronic mail address for the addressee may be printed on the mailpiece and/or stored in an RFID (radio frequency identification) tag affixed to the mailpiece.

Following the instructions may in some cases include opening the mailpiece, placing in another envelope a document contained in the mailpiece, and delivering the other envelope, with the document therein, to the addressee.

Following the instructions may in some cases include informing the sender and/or the addressee of the event.

Following the instructions may include changing (e.g., upgrading) a class of service that is applicable to the mailpiece.

Determining the instructions may take place, at least in part, by reading a barcode on the mailpiece and/or reading data from an RFID tag affixed to the mailpiece.

The method may further include storing data indicative of the detected event in an RFID tag affixed to the mailpiece.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic plan view of a mailpiece provided according to some aspects of the invention.

FIGS. 2A and 2B together form a flow chart that illustrates a process that may be provided in accordance with the invention for responding to an event in which delivery of a mailpiece is delayed.

FIG. 3 is a block diagram that illustrates a system provided according to some embodiments of the invention.

FIG. 4 is a flow chart that illustrates a process that may be performed with the aid of the system of FIG. 3.

FIG. 5 is a block diagram that illustrates an apparatus provided according to some embodiments of the invention.

FIG. 6 is a flow chart that illustrates a process that may be performed using the apparatus of FIG. 5.

### DETAILED DESCRIPTION

In the methods of the present invention, a sender of a mailpiece is allowed to provide instructions, before or after the fact, to direct a mailpiece delivery service to respond in accordance with the sender's wishes in response to planned or unplanned events that occur during the delivery service's handling of the mailpiece. The instructions may direct the delivery service to effectively restore a channel of communication from the sender to an addressee of the mailpieces even though the delivery of the mailpiece itself is either delayed or permanently disrupted.

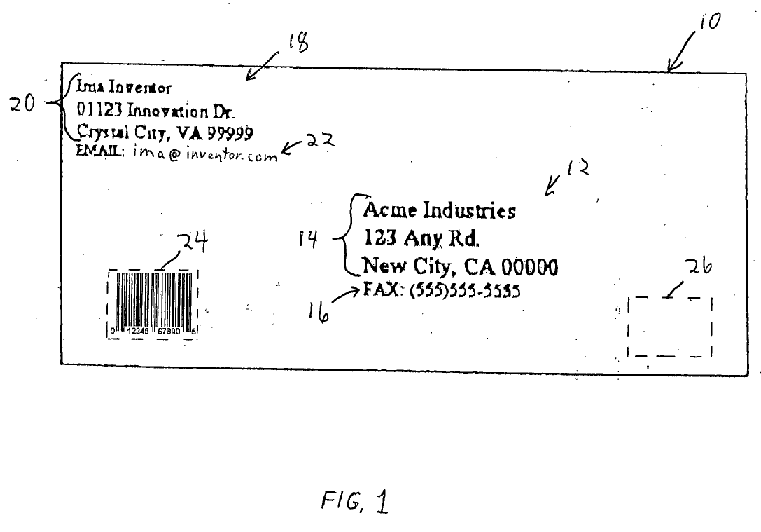

FIG. 1 is a schematic plan view of a mailpiece 10 provided according to some aspects of the invention. The mailpiece 10 has an addressee field 12. The addressee field 12 includes a conventional street address 14 (including the name of the addressee) for the addressee of the mailpiece 10, and alternate contact information 16 for the addressee (in this case, a facsimile machine telephone number). In other embodiments, the alternate contact information 16 may include an electronic mail address and/or a telephone (voice) number for the addressee of the mailpiece in addition to or instead of the facsimile machine telephone number.

The mailpiece 10 also has a return address field 18. The return address field includes a conventional street address 20 (including the name of the sender of the mailpiece 10) for the sender of the mailpiece, and alternate contact information 22 for the sender (in this case, an electronic mail address for the sender). In other embodiments, the alternate contact information 22 may include a facsimile machine telephone number and/or a voice telephone number for the sender of the mailpiece in addition to or instead of the electronic mail address for the sender.

According to some embodiments, a barcode 24 (indicated in phantom) may be printed on the mailpiece 10. The barcode 24 may serve to uniquely identify the mailpiece, or, alternatively, may identify a category to which the mailpiece belongs. As will be seen, the category may be defined to indicate one or more instructions to be followed with respect to the mailpiece upon occurrence of one or more events. In some embodiments, the presence of the barcode 24 may make it feasible to omit either or both of the addressee alternate contact information 16 and the sender alternate contact information 22 while still providing at least some functions in accordance with the invention.

In some embodiments, instead of being printed directly on the mailpiece, the barcode 24 may be printed on a sticker which is adhered to the mailpiece. As used herein and in the appended claims, “printed on a mailpiece” shall be understood to included printed on a sticker which adheres to the mailpiece.

In some embodiments, a mailpiece identification number and/or a mailpiece category identification number may be printed on the mailpiece in the form of alphanumeric characters instead of or in addition to the barcode 24.

According to some embodiments, an RFID tag 26 (indicated in phantom) may be affixed to the mailpiece 10. “Affixed to the mailpiece” may include adhered or otherwise attached to the exterior of the mailpiece, formed by printing on the mailpiece, and/or embedded, inserted or contained within the mailpiece.

The RFID tag 26 may store a mailpiece and/or tag identification number which uniquely identifies the mailpiece or at least identifies a category to which the mailpiece belongs. The RFID tag may also store other data, including for example alternate contact information (e.g., one or more of electronic mail address, facsimile machine telephone number, voice telephone number) for either or both of the sender and the addressee. It may therefore not be necessary to include on the face of the mailpiece 10 either or both of the printed alternate contact information 16, 22.

In some embodiments, the alternate contact information for the sender or addressee, whether printed on the mailpiece or stored in an RFID tag affixed to the mailpiece, may include a URL (uniform resource locator).

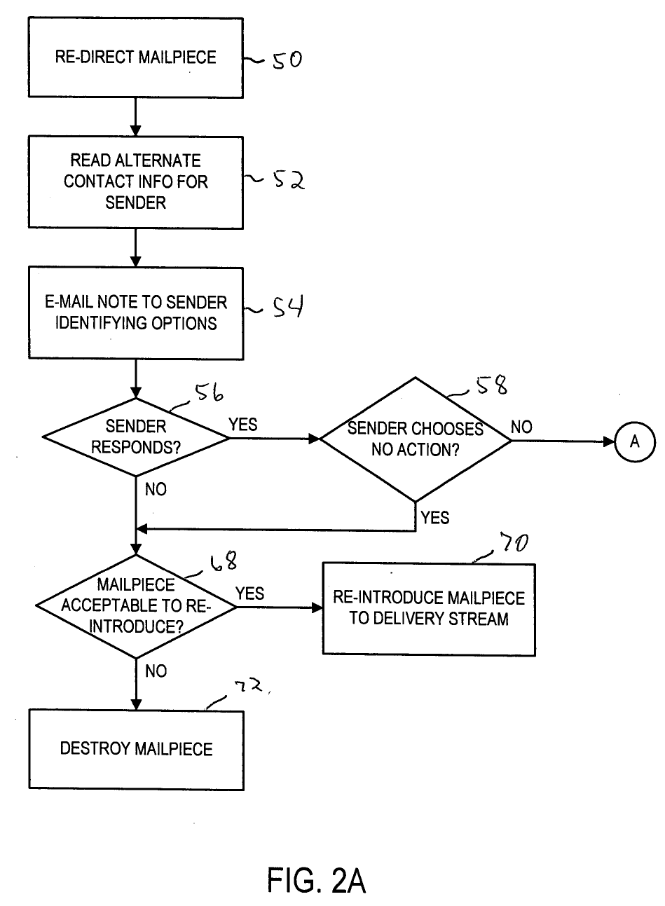

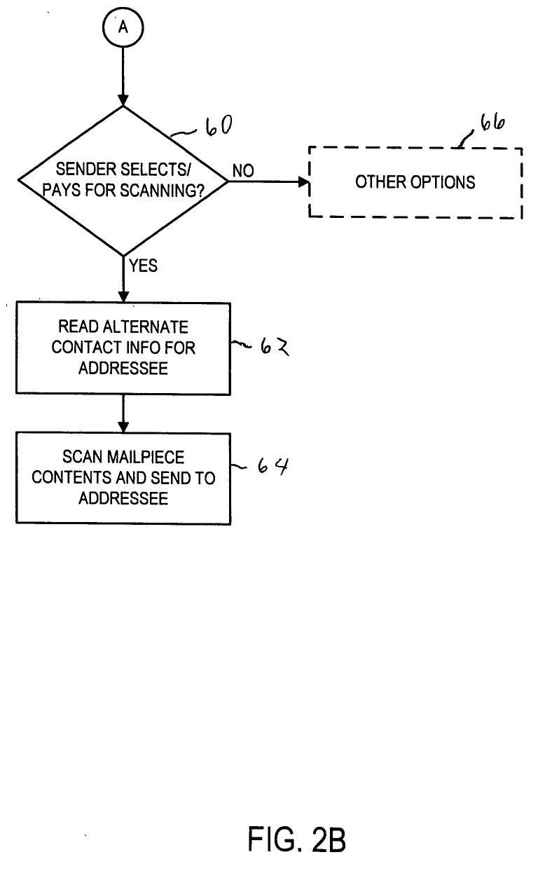

FIGS. 2A and 2B together form a flow chart that illustrates a process that may be provided in accordance with the invention for responding to an event in which delivery of the mailpiece 10 is delayed. In one embodiment, it is assumed that some event has occurred that has resulted in a delay, potentially a lengthy delay, in delivery of the mailpiece 10. For example, the mailpiece may have been contaminated and therefore quarantined. As a result, the mailpiece is, as indicated at step 50 in FIG. 2A, re-directed or retained in a holding facility instead of being advanced along the normal course toward delivery to the addressee. In accordance with some aspects of the invention, the delivery agent (e.g., the U.S. Postal Service) reads from the mailpiece alternate contact information for the sender of the mailpiece (step 52). This may be done, in some cases, by reading data from the RFID tag, if present. In other cases, for example, an employee of the delivery agent may read the alternate contact information. The alternate contact information may be, for example, the sender's electronic mail address.

Either automatically or by activity of an employee, the delivery agent may then contact the sender (e.g., by e-mail, step 54) to apprise the sender of one or more options available to the sender to at least partially take remedial steps in view of the re-direction of the mailpiece. A determination is then made, at block 56, as to whether the sender responds to the contact made at step 54. If so, it is next determined, at block 58, whether the sender has selected at least one remedial option. If so, it is next determined, at block 60 in FIG. 2B, whether the sender has selected and/or agreed to pay for a remedial option which entails scanning of the contents of the mailpiece.

If a positive determination is made at 60, the delivery agent reads alternate contact information for the addressee (step 62). This may be done, for example, by reading out data from the RFID tag, if present on the mailpiece, or simply by reading the printed addressee alternate contact information 16. The mailpiece may then be opened and a document (e.g., a letter) or document contained therein may be scanned (step 64), by using a facsimile machine, for example, to send the contents by fax to the addressee using the alternate contact information read at step 62. In other cases, the scanning may be by a computer scanner, and the contents may be sent to the addressee by e-mail. The e-mail message to the addressee may contain either or both of (a) image data and (b) text data generated by optical character recognition applied to the scanned document. Accordingly, the alternate contact information read at step 62 may be either or both of an electronic mail address or a facsimile machine telephone number for the addressee.

If the sender does not select the remedial option which uses scanning to pass the mailpiece contents to the addressee, the sender may be presented with other options (indicated in phantom at 66 in FIG. 2B). For example, the delivery agent may provide a notification to the addressee by telephone, fax or e-mail that the mailpiece is delayed. As another example, the delivery agent may provide a written certification to the addressee that the mailpiece was duly mailed by the sender, but is delayed. In still another option, the mailpiece may be opened, the contents may be sterilized or otherwise treated, and the contents may then be placed in another envelope which is then delivered to the addressee.

Considering again decision block 56 (FIG. 2A), if it is determined that the sender has not responded within a certain period of time to the contact made in step 54, then a determination may be made at block 68 (FIG. 2A) as to whether the mailpiece is in a condition (e.g., no longer contaminated) such that the mailpiece can now be delivered to the addressee. If so, then the mailpiece is re-introduced into the delivery stream and ultimately delivered to the addressee (step 70). If it is determined at block 68 that the mailpiece is not in a condition to be returned to the delivery stream, then it is destroyed (step 72).

Similarly, if the sender elects at block 58 not to take remedial action, then steps 68 and 70 or 72 (as the case may be) follow block 58, as if the sender had not responded to the contact at step 54.

With the process described above in connection with FIGS. 2A-2B, the sender of a mailpiece is given at least some options to complete the communication with the addressee that was disrupted by the re-direction of the mailpiece. Thus the process of FIGS. 2A-2B may allow for a graceful recovery from an event which delays or prevents delivery of a mailpiece, by the delivery agent soliciting and then following instructions from the sender of the mailpiece.

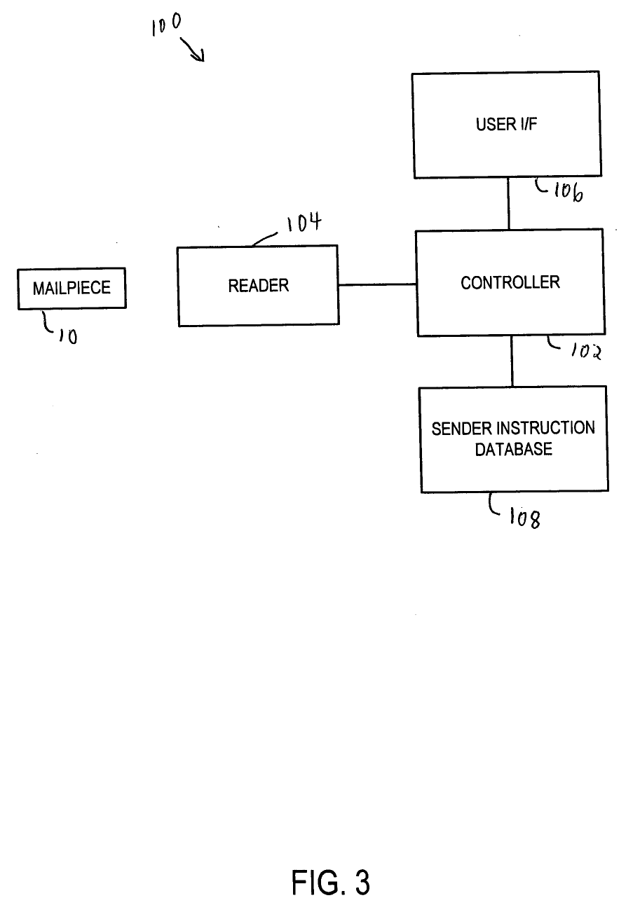

FIG. 3 is a block diagram that illustrates a system 100 provided according to some embodiments of the invention. The system 100 may make it possible to implement instructions previously recorded by a sender of a mailpiece to be followed in the event of a delay in delivering the mailpiece or in case of other types of events. The system may be one of a considerable number of such systems deployed by a delivery agent such as the U.S. Postal Service.

The system 100 includes a controller 102, which in some embodiments may be a suitably programmed personal computer (not separately shown). In another embodiment, the system 100 may also include a reader or readers 104 coupled to the controller 102. The reader(s) 104 may be adapted to read an RFID tag (FIG. 1, not separately shown in FIG. 3) that is affixed to a mailpiece 10 and/or to read a barcode (FIG. 1, not separately shown in FIG. 3) that is printed on the mailpiece 10.

The system may also include a user interface 106 that is coupled to the controller 102. The user interface may include, for example, one or more input/output devices (not separately shown) that enable a human operator to interact with the system 100. In addition, the system 100 may include a database 108 of instructions that senders may have previously issued to be followed by the delivery agent upon occurrence and/or detection of various types of events in connection with the delivery agent's handling of mailpieces. The events may include normal events such as intake, various stages of processing or transportation, and delivery of mailpieces. In addition, the events may include unplanned events, such as delay, re-direction, contamination and/or quarantining of mailpieces.

Although the database 108 is shown as directly connected to the controller 102, in some embodiments the database may be maintained in a central location that is remote from the controller 102. In such cases, the controller 102 may access the database 108 via a data communication network, which is not separately shown.

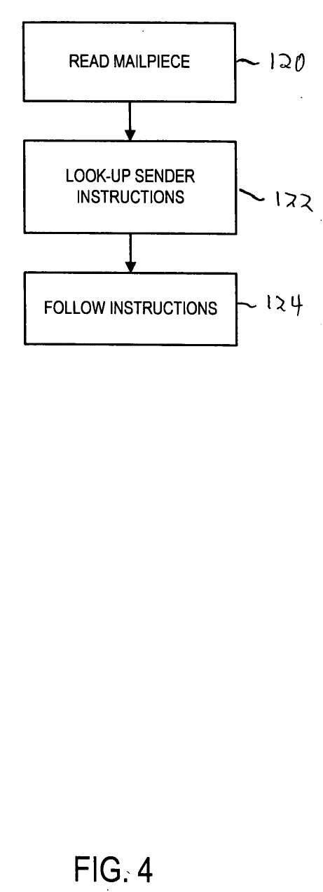

FIG. 4 is a flow chart that illustrates a process that may be performed with the aid of the system 100. It is assumed for the purposes of the process of FIG. 4 that an event occurs/is detected. The event may be either a planned event or an unplanned event, such as those described above. For example, the event may be a delay/re-direction and/or quarantine of the mailpiece. In response to the event and/or detection thereof, the system 100 may read a barcode and/or RFID tag on the mailpiece, as indicated at step 120 in FIG. 4. The data read from the barcode or RFID tag may uniquely identify the mailpiece or may at least indicate a category of mailpieces to which the mailpiece belongs. (In some cases, a mailpiece identification number or mailpiece category number printed in the form of alphanumeric characters on the mailpiece may be read by a human operator. The operator may then input the I.D./category number into the system 100.)

Then at step 122, the controller 102 may access the database 108 to determine an instruction or instructions previously submitted or specified by the sender in regard to the type of event in question and in regard to the particular mailpiece or the category of mailpieces to which the particular mailpiece belongs. For example, the mailpiece may be barcoded to belong to a category for which a scan-and-forward instruction has been submitted by the sender. The scan-and-forward instruction may be applicable to an event in which the mailpiece is quarantined. The scan-and-forward instruction may also include alternate contact information for the addressee of the particular mailpiece, or may direct that the alternate contact information be read from the face of the mailpiece or from an RFID tag affixed to the mailpiece.

At step 124, the delivery agent follows the instruction(s) looked up at step 122. In the case of a scan-and-forward instruction, the mailpiece may be opened, and the contents scanned and forwarded to the addressee, in essentially the same manner as described above in connection with FIG. 2B. In other cases, other types of instructions may be in effect. For example, if the event is intake of the mailpiece to the delivery agent (a planned event), the instruction may be to notify the addressee that the mailpiece is on the way. If the event is delivery of the mailpiece to the addressee (again a planned event), the instruction may be to notify the sender of the delivery. Similar events and instructions may be implemented for other stages of handling of the mailpiece by the delivery agent.

In some embodiments, if a mailpiece is delayed, the sender's instructions may call for the class of service for the mailpiece to be upgraded (e.g., from first class to overnight express, or from “standard” mail to first class), and the delivery agent may act accordingly.

In some embodiments, the sender's instruction(s) may be stored in the RFID tag itself, and may be read by the reader 104, thereby allowing the system 100 to determine the instruction(s). In such cases, the controller 102 may not need to access the database 108 to determine the sender's instructions and/or the database 108 may be dispensed with.

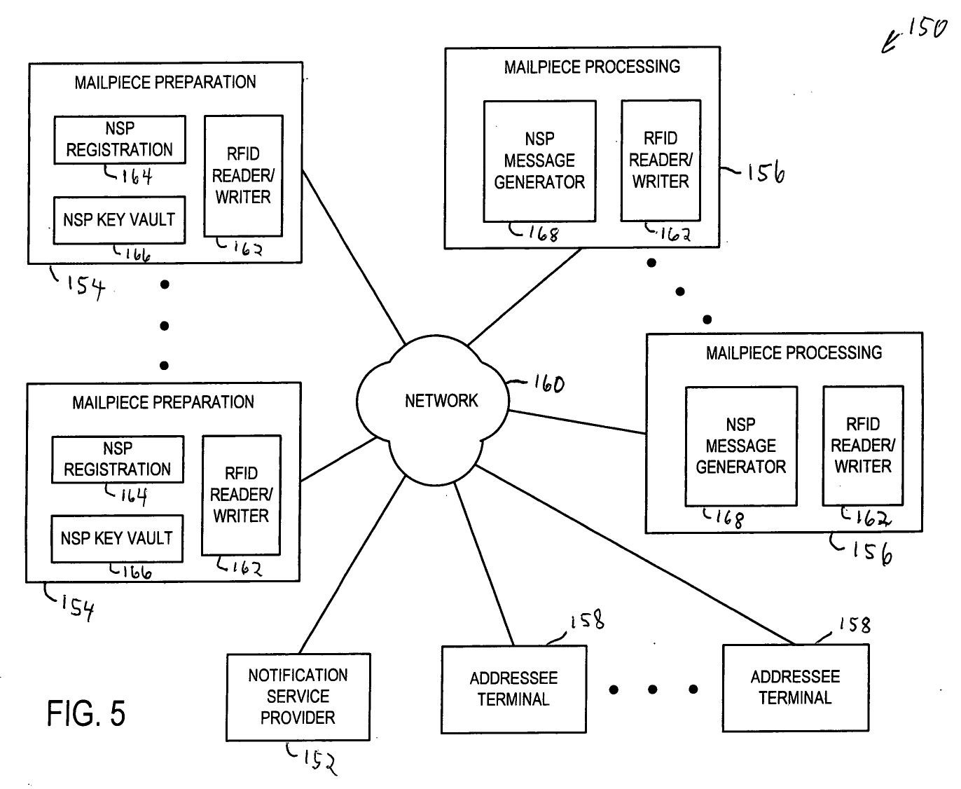

FIG. 5 is a block diagram that illustrates a system 150 provided according to some embodiments of the invention. In another embodiment, the system 150 may be particularly suitable for automatically sending messages to senders and/or addressees of mailpieces to notify them as planned events occur during the delivery agent's handling of the mailpieces. In the system 150 senders may be allowed to tailor the types of messages to be provided by the system to particular mailpieces or classes or groups of mailpieces.

The major components of the system 150 are a notification service provider (NSP) 152, a number of mailpiece preparation facilities 154, a number of mailpiece processing facilities 156, a number of addressee terminals 158 and a data communication network 160. The data communication network 160 may be a public network such as the Internet, and may allow each other component of the system 150 to engage in data communications with at least some of the other components of the system 150.

The notification service provider 152 may be implemented as a server computer that receives and stores senders' instructions as to the type(s) of message(s) to be provided by the system at one or more stages of handling of the mailpieces by the delivery agent. As will be seen, the notification server provider 152 also receives inquiries from the delivery agent(s) regarding what sorts of notification messages are to be provided by the delivery agent(s).

Each sender who participates in the system 150 may have one or more of the mailpiece preparation facilities 154. In addition to a computerized controller (not separately shown), each mailpiece preparation facility 154 may include conventional mailpiece preparation equipment, such as a printer or printers, folders, inserters etc. Further, each mailpiece preparation facility may include an RFID reader and/or writer 162 to allow the facility to read data from and/or write data into RFID tags affixed or to be affixed to the mailpieces. In addition, each mailpiece preparation facility 154 may include a functional block 164 that handles registration of the sender's instructions with the notification service provider 152. The NSP registration block 152 may, for example, be implemented with suitable software running on the above mentioned controller portion of the mailpiece preparation equipment. Further, each mailpiece preparation facility may include a functional block 166 to manage encryption keys that are used to encrypt messages sent by the system 150 with respect to a particular mailpiece.

Each delivery agent who participates in the system 150 (there may be only one delivery agent) may have a considerable number of mailpiece processing facilities 156. In addition to a computerized controller (not separately shown), each mailpiece processing facility may include conventional mailpiece sorters and/or other types of mail handling equipment. Also, each mailpiece preparation facility may include an RFID reader/writer 162 to read and/or write data from and/or to RFID tags affixed to mailpieces handled by the mail handling equipment. Also, each mailpiece processing facility 156 may include a functional block 168 that interacts with the notification service provider 152 and which generates messages in accordance with instructions registered by senders with the notification service provider 152.

The addressee terminals 158 are held by addressees and may be constituted by conventional personal computers or the like. In cases where an addressee is also a sender, the addressee terminal may be integrated with a mailpiece preparation facility 154.

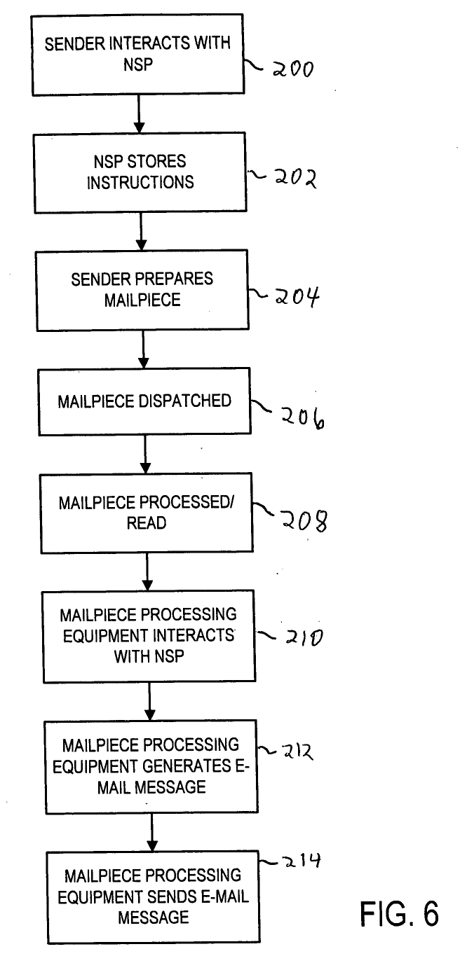

FIG. 6 is a flow chart that illustrates a process that may be performed using the system 150.

Initially in the process of FIG. 6, at step 200, a mailpiece preparation facility 154 interacts with the notification service provider 152. In particular the mailpiece preparation facility 154 may register one or more instructions with the notification service provider 152, which stores the instructions (step 202). In addition, the NSP may provide a registration number to the mailpiece preparation facility 154. The mailpiece preparation facility may then write the registration number into an RFID tag affixed or to be affixed to a mailpiece, as part of the preparation of the mailpiece (step 204) by the mailpiece preparation facility 154. The mailpiece is then turned over (step 206) by the sender to the delivery agent for transportation and delivery to the addressee.

As the mailpiece is handled by the delivery agent, it is handled by one or more mailpiece processing facilities 156 of the delivery agent. At each of the mailpiece processing facilities, the RFID tag affixed to the mailpiece may be read (step 208) by the RFID reader/writer 162 that is part of the mailpiece processing facility. The data read from the RFID tag may include the registration number that was assigned by the NSP. The mailpiece processing facility may then interact (step 210) with the NSP 152 to determine whether the instructions registered by the sender call for a notification message to be generated at this stage of handling of the mailpiece, and if so, what sort of message is to be generated. (Alternatively, in some embodiments, the RFID tag itself may contain at least some elements of instructions to be carried out by the mailpiece processing facility 156, such as when and/or to whom a notification message is to be sent.)

In some embodiments, when a mail processing facility 156 processes a mailpiece, the RFID reader/writer 162 may write into the RFID tag affixed to the mailpiece event data that indicates, e.g., the identity of the mail processing facility, the nature of the handling (event) and/or the date and time of the event. As a result, the RFID tag may accumulate and store a historical record of the handling of the mailpiece by the delivery agent.

Then, as indicated at step 212 in FIG. 6, the mailpiece processing facility 156 may generate an e-mail message, in accordance with instructions determined by the mailpiece processing facility's interaction with the NSP 152 and/or based on instructions read from the RFID tag affixed to the mailpiece. The mailpiece processing facility then sends the e-mail message (step 214) to the sender (e.g., at its mailpiece preparation facility 154) and/or to the addressee (at its addressee terminal 158), as provided for in the sender's instructions. In additional embodiments, known data storage systems or devices may be utilized in place of the RFID tag.

With the systems 100, 150 described above, or with the process of FIGS. 2A-2B, the sender of a mailpiece is accorded great flexibility in prescribing what reporting messages or other actions are to be taken by a delivery agent upon occurrence of planned events and/or unplanned events. As a result, the invention may provide senders with improved opportunities to track and manage mailing/shipping operations, even in the case of unplanned events that disrupt the delivery process.

Where encryption of the e-mail message is necessary or desirable, a suitable encryption key or keys may be provided (e.g., by secure communications) to the delivery agent (mailpiece processing facilities 156) and to the addressee terminals 158, to allow for encryption and decryption of the e-mail messages.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

A number of embodiments of the present invention have been described. Nevertheless, it will be understood that various modifications may be made without departing from the spirit and scope of the invention. Accordingly, other embodiments are within the scope of the following claims.

What is claimed is:

1. A method comprising:
detecting an event which occurs during transportation of a mailpiece on the way from a sender to an addressee;
determining instructions provided by the sender regarding at least one action to be taken upon occurrence of said event; and
following said instructions.

2. The method according to claim 1, wherein the following instructions step includes informing the sender of the event.

3. The method according to claim 1, wherein the following instructions step includes:
opening the mailpiece;
scanning a document contained in the mailpiece to generate scanned data; and
transmitting the scanned data to the addressee.

4. The method according to claim 3, wherein the transmitting includes sending the scanned data to the addressee via electronic mail.

5. The method according to claim 4, wherein an electronic mail address for the addressee is printed on the mailpiece.

6. The method according to claim 4, wherein an electronic mail address for the addressee is stored in a radio frequency identification (RFID) tag affixed to the mailpiece.

7. The method according to claim 3, wherein the transmitting includes sending the scanned data to the addressee in the form of a facsimile message.

8. The method according to claim 7, wherein a facsimile machine telephone number for the addressee is printed on the mailpiece.

9. The method according to claim 7, wherein a facsimile machine telephone number for the addressee is stored in a radio frequency identification (RFID) tag affixed to the mailpiece.

10. The method according to claim 1, wherein the following instructions step includes:
opening the mailpiece;
placing in another envelope a document contained in the mailpiece; and
delivering the another envelope, with the document therein, to the addressee.

11. The method according to claim 1, wherein the following instructions step includes informing the addressee of the event.

12. The method according to claim 1, wherein the event is a delay in transporting the mailpiece.

13. The method according to claim 12, wherein the event further comprises quarantining the mailpiece on account of contamination of the mailpiece.

14. The method according to claim 1, wherein the event is delivery of the mailpiece to a post office box and the following instructions step includes sending an electronic mail message to the addressee to inform the addressee of said delivery.

15. The method according to claim 1, wherein the instructions are determined, at least in part, by reading a barcode on the mailpiece.

16. The method according to claim 1, wherein the instructions are determined, at least in part, by reading data from a radio frequency identification (RFID) tag affixed to the mailpiece.

17. The method according to claim 1, wherein the following instructions step includes changing a class of service that is applicable to the mailpiece.

18. The method according to claim 17, wherein the following instructions step includes upgrading the class of service that is applicable to the mailpiece.

19. The method according to claim 1, wherein a radio frequency identification (RFID) tag is affixed to the mailpiece; and further comprising storing in the RFID tag data indicative of the detected event.

20. A mailpiece having a radio frequency identification (RFID) tag affixed thereto, the RFID tag storing data that indicates at least one of (i) an electronic mail address of an addressee for the mailpiece, and (ii) a facsimile machine telephone number of the addressee.

21. A method comprising:
detecting an event which occurs during transportation of a mailpiece on the way from a sender to an addressee; and
responding to the detected event by:
opening the mailpiece;
scanning a document contained in the mailpiece to generate scanned data; and
transmitting the scanned data to the addressee.

22. The method according to claim 21, wherein the transmitting includes sending the scanned data to the addressee via electronic mail.

23. The method according to claim 22, wherein an electronic mail address for the addressee is printed on the mailpiece.

24. The method according to claim 22, wherein an electronic mail address for the addressee is stored in a radio frequency identification (RFID) tag affixed to the mailpiece.

25. The method according to claim 21, wherein the transmitting includes sending the scanned data to the addressee in the form of a facsimile message.

26. The method according to claim 25, wherein a facsimile machine telephone number for the addressee is printed on the mailpiece.

27. The method according to claim 25, wherein a facsimile machine telephone number for the addressee is stored in a radio frequency identification (RFID) tag affixed to the mailpiece.

28. A method comprising:
delivering a mailpiece to a post office box; and
sending an electronic mail message to a holder of the post office box to inform the holder of the delivery of the mailpiece.
